(19) United States
(12) Patent Application Publication
(10) Pub. No.: US 2024/0264191 A1
(43) Pub. Date: Aug. 8, 2024

(54) APPARATUS AND METHODS FOR ACTUATING FLUIDS IN A BIOSENSOR CARTRIDGE

(71) Applicant: SiPhox, Inc., Burlington, MA (US)

(72) Inventors: Azra Horowitz, New York, NY (US); Diedrik Vermeulen, Arlington, MA (US); Armando Paredes, Lincoln, MA (US); Michael Dubrovsky, Somerville, MA (US)

(73) Assignee: SiPhox, Inc., Burlington, MA (US)

(21) Appl. No.: 18/107,135

(22) Filed: Feb. 8, 2023

Related U.S. Application Data
(60) Provisional application No. 63/287,420, filed on Dec. 8, 2021.

(51) Int. Cl. G01N 35/10

(52) U.S. Cl. CPC G01N 35/1009; G01N 2035/1034

(57) ABSTRACT

An apparatus for actuating of fluids in a biosensor cartridge, the apparatus includes a microfluidic device, the microfluidic device includes a microfluidic circuit comprising at least a reservoir configured to contain at least a fluid and an active flow component in fluidic communication with the at least a reservoir, wherein the active flow component comprises a barrel and a plunger at a first position within the barrel, and an actuator configured to initiate an active flow process, wherein initiating the active flow process comprises accepting the plunger using a mechanical interface mechanically communicated to the actuator and moving the plunger within the barrel from the first position to a second position based on predetermined flow properties, and flow the at least a fluid unidirectionally as a function of the active flow process.

### CROSS-REFERENCE TO RELATED APPLICATIONS

This application claims the benefit of priority of U.S. Provisional Patent Application Ser. No. 63/287,420, filed on Dec. 8, 2021, and titled “METHODS FOR ACTUATION OF FLUIDS IN A BIOSENSOR CARTRIDGE,” which is incorporated by reference herein in its entirety.

### FIELD OF THE INVENTION

The present invention generally relates to the field of fluid flow actuation in a biosensing platform. In particular, the present invention is directed to apparatus and methods for actuation of fluids in a biosensor cartridge.

### BACKGROUND

Currently used analytical methods in bioassays, including those used for rapid, point-of-care medical diagnostics, are lacking in accuracy and efficiency.

### SUMMARY OF THE DISCLOSURE

In an aspect, an apparatus for actuating fluids in a biosensor cartridge is described. The apparatus includes a microfluidic device, the microfluidic device includes a microfluidic circuit comprising at least a reservoir configured to contain at least a fluid and an active flow component in fluidic communication with the at least a reservoir, wherein the active flow component comprises a barrel and a plunger at a first position within the barrel, and an actuator configured to initiate an active flow process, wherein initiating the active flow process comprises accepting the plunger using a mechanical interface mechanically communicated to the actuator and moving the plunger within the barrel from the first position to a second position based on predetermined flow properties, and flow the at least a fluid unidirectionally as a function of the active flow process.

In another aspect, a method for actuating of fluids in a biosensor cartridge is described. The method includes initiating, using an actuator, an active flow process as a function of an active flow component of a microfluidic device, wherein the microfluidic device further including a microfluidic circuit containing at least a reservoir configured to contain at least a fluid, the active flow component in fluidic communication with the at least a reservoir, the active flow component includes a barrel and a plunger at a first position within the barrel, and initiating the active flow process includes accepting the plunger using a mechanical interface mechanically communicated to the actuator and moving the plunger within the barrel from the first position to a second position based on predetermined flow properties, and flowing, using the actuator, the at least a fluid unidirectionally as a function of the active flow process.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a general system architecture discussed herein for actuating fluids in a biosensing cartridge;

FIG. 2 shows a general functionality of a plunger moved by an actuator contained in an assembly that interfaces with the cartridge;

FIG. 3 illustrates a bi-directional (reverse and forward) flow for a general two-step assay.

FIG. 4A-B shows a cross-sectional view of an example embodiment of a plunger containing a feature that allows it to interface with a linear actuator, constrained within a cylindrical barrel inside the cartridge, as described in an exemplary embodiment;

FIG. 5 illustrates a three-dimensional view of an exemplary embodiment;

FIG. 6 illustrates a prototype of an exemplary embodiment;

FIG. 7 illustrates an exemplary embodiment schematically wherein the plunger may be constrained within a cylindrical barrel inside the cartridge;

FIG. 8 shows a prototype for an exemplary embodiment using an alligator clip to grip the shaft;

FIG. 9 shows an example of rotary actuation of the plunger wherein the plunger is linked to a central hub such that the plunger is actuated by hub rotation;

FIGS. 10A-C outlines various methods for multi-step assays;

FIG. 11 illustrates how multiple assay steps may be performed by having two input wells on the same cartridge;

FIG. 12 shows how the syringe may be used in a multistep workflow in the cartridge utilizing a pierceable seal;

FIG. 13 is a flow diagram of an exemplary embodiment of a method for actuating fluids in a biosensing cartridge; and

FIG. 14 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for actuating fluids in a biosensing cartridge. In an embodiment, apparatus includes a microfluidic device containing a microfluidic circuit, wherein the microfluid circuit includes at least a reservoir configured to contain at least a fluid. Apparatus includes an actuator configured to initiate an active flow process and flow the at least a fluid contained in the at least a reservoir of microfluid circuit within the microfluidic device unidirectionally as a function of the active flow process.

Aspects of the present disclosure can be used to test fluid samples. Aspects of the present disclosure can also be used to test biological samples. Exemplary embodiments illustrating aspects of the present disclosure are described below in the context of several specific examples.

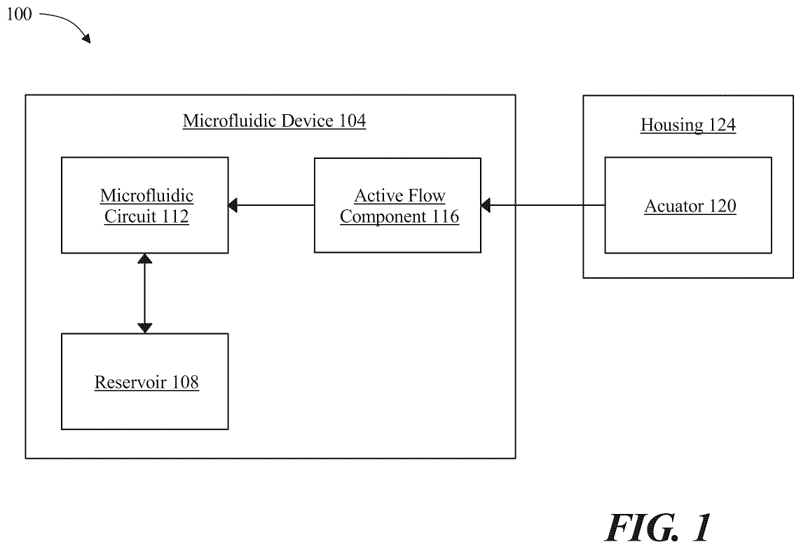

Referring now to FIG. 1, an exemplary embodiment of an apparatus 100 for actuating fluids in a biosensor cartridge is illustrated. As used in this disclosure, a “biosensor cartridge” refers to the microfluidic device described below in this disclosure. Apparatus 100 may include a computing device. Computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented using a “shared nothing” architecture in which data is cached at the worker, in an embodiment, this may enable scalability of apparatus 100 and/or computing device.

With continued reference to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a microfluidic device 104. As used in this disclosure, a “microfluidic device” is a device that is configured to act upon fluids at a small scale, such as without limitation a sub-millimeter scale. At small scales, surface forces may dominate volumetric forces. In a non-limiting example, microfluidic device may be consistent with any microfluidic device described in U.S. patent application Ser. No. 17/859,932, filed on Jul. 7, 2022, entitled “SYSTEM AND METHODS FOR FLUID SENSING USING PASSIVE FLOW,” the entirety of which is incorporated herein by reference.

With continued reference to FIG. 1, microfluidic device 104 includes at least a reservoir 108. Reservoir 108 may be configured to contain at least a fluid. In a non-limiting example, fluid may include a sample fluid to be analyzed from a subject; for instance, and without limitation, reservoir 108 of microfluidic device 104 may contain a blood sample taken from a patient. Alternatively, or additionally, fluid may include one or more suspensions and/or solutions of reagents, molecules, or other items to be analyzed and/or utilized, including without limitation monomers such as individual nucleotides, amino acids, or the like, one or more buffer solutions and/or saline solutions for rinsing steps, and/or one or more analytes to be detected and/or analyzed. Fluid and/or microfluidic device may be used, without limitation, in processes as disclosed in U.S. Nonprovisional application Ser. No. 17/337,931, filed on Jun. 3, 2021 and entitled “METHODS AND SYSTEMS FOR MONOMER CHAIN FORMATION,” and/or as disclosed in U.S. Nonprovisional application Ser. No. 17/403,480, filed on Aug. 16, 2021 and entitled “TAGGED-BASE DNA SEQUENCING READOUT ON WAVEGUIDE SURFACES,” the entirety of each of which is incorporated herein by reference. Reservoir 108 may have at least an inlet, at least an outlet, or both. Reservoir 108 may further include, without limitation, a well, a channel, a flow path, a flow cell, a pump, and the like. In a non-limiting example, fluid may be input through the at least an inlet into reservoir 104 and/or output through the at least an outlet. At least an outlet may be connected to other components and/or devices within microfluidic device 104; for instance, and without limitation, at least an outlet may be connected to microfluidic circuit as described below in this disclosure.

With continued reference to FIG. 1, microfluidic device 104 may include a passive flow component. As used in this disclosure, a “passive flow component” is a component, typically of a microfluidic device, that imparts a passive flow on a fluid. As used in this disclosure, “passive flow” is flow of fluid, which is induced absent any external actuators, fields, or power sources. Passive flow techniques may include, without limitation osmosis, capillary action, surface tension, pressure, gravity-driven flow, hydrostatic flow, vacuums, and the like. Passive flow component may be in fluidic communication with at least a reservoir 108. Passive flow component may be configured to flow at least a fluid stored in at least a reservoir 108 with predetermined flow properties. As used in this disclosure, “flow properties” are characteristics related to a flow of a fluid. For instance, exemplary non-limiting flow properties include flow rate (in μl/min), flow velocity, integrated flow volume, pressure, differential pressure, and the like.

With continued reference to FIG. 1, microfluidic device 104 includes an active flow component 116. As used in this disclosure, an “active flow component” is a component that imparts an active flow on a fluid. As used in this disclosure, “active flow” is flow of fluid which is induced by external actuators, fields, or power sources. In some embodiments, active flow component 116 is in fluidic communication with at least a reservoir 108. In a non-limiting example, active flow component 116 may include one or more pumps. Pump may include a substantially constant pressure pump (e.g., centrifugal pump) or a substantially constant flow pump (e.g., positive displacement pump, gear pump, and the like). Pump can be hydrostatic or hydrodynamic. As used in this disclosure, a “pump” is a mechanical source of power that converts mechanical power into fluidic energy. A pump may generate flow with enough power to overcome pressure induced by a load at a pump outlet. A pump may generate a vacuum at a pump inlet, thereby forcing fluid from a reservoir into the pump inlet to the pump and by mechanical action delivering this fluid to a pump outlet. Hydrostatic pumps are positive displacement pumps. Hydrodynamic pumps can be fixed displacement pumps, in which displacement may not be adjusted, or variable displacement pumps, in which the displacement may be adjusted. Exemplary non-limiting pumps include gear pumps, rotary vane pumps, screw pumps, bent axis pumps, inline axial piston pumps, radial piston pumps, and the like. Pump may be powered by any rotational mechanical work source, for example without limitation and electric motor or a power take off from an engine. Pump may be in fluidic communication with at least a reservoir 108. In some cases, reservoir 108 may be unpressurized and/or vented. Alternatively, reservoir 108 may be pressurized and/or sealed. Active flow component 116 may be described in further detail below.

With continued reference to FIG. 1, microfluidic device 104 may include a sensor device. Sensor device may be configured to be in sensed communication with at least a fluid contained within or otherwise acted upon by microfluidic device 104. As used in this disclosure, a “sensor device” is any device including at least a sensor that detects property as a function of a phenomenon. In some embodiments, a sensor device may include an optical device. As used in this disclosure, an “optical device” is any device that generates, transmits, detects, or otherwise functions using electromagnetic radiation, including without limitation ultra-violet light, visible light, near infrared light, infrared light, and the like. In some embodiments, optical device may include one or more waveguide. As used in this disclosure, a “waveguide” is a component that is configured to propagate electromagnetic radiation, including without limitation ultra-violet light, visible light, near infrared light, infrared light, and the like. A waveguide may include a lightguide, a fiberoptic, or the like. A waveguide may include a grating within a transmissive material. In some cases, a waveguide may be configured to function as one or more optical devices, for example a resonator (e.g., microring resonator), an interferometer, or the like. In some cases, waveguide may be configured to propagate an electromagnetic radiation (EMR). In a non-limiting example, sensor device may include any sensor device described in U.S. patent application Ser. No. 17/859,932 and/or any other disclosure incorporate by reference herein. Sensor device may include a sensor, wherein the sensor may be optical communication with one or more waveguide. Such sensor may be configured to detect a variance in at least an optical property associated with the at least a fluid. As used in this disclosure, an “optical property” is any detectable characteristic associated with electromagnetic radiation, for instance UV, visible light, infrared, and the like. In some cases, sensor device may generate and/or communicate signal representative of the detected property.

Still referring to FIG. 1, in some embodiments, sensor may be in communication with the computing device. For instance, and without limitation, sensor 128 may communicate with computing device using one or more signals. As used in this disclosure, a “signal” is a human-intelligible and/or machine-readable representation of data, for example and without limitation an electrical and/or digital signal from one device to another; signals may be passed using any suitable communicative connection. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. A signal may include an optical signal, a hydraulic signal, a pneumatic signal, a mechanical signal, an electric signal, a digital signal, an analog signal and the like. In some cases, a signal may be used to communicate with a computing device, for example by way of one or more ports. In some cases, a signal may be transmitted and/or received by computing device, for example by way of an input/output port. An analog signal may be digitized, for example by way of an analog to digital converter. In some cases, an analog signal may be processed, for example by way of any analog signal processing steps described in this disclosure, prior to digitization. In some cases, a digital signal may be used to communicate between two or more devices, including without limitation computing devices. In some cases, a digital signal may be communicated by way of one or more communication protocols, including without limitation internet protocol (IP), controller area network (CAN) protocols, serial communication protocols (e.g., universal asynchronous receiver-transmitter [UART]), parallel communication protocols (e.g., IEEE 128 [printer port]), and the like.

Still referring to FIG. 1, in some cases, apparatus 100, sensor, and/or computing device may perform one or more signal processing steps on a signal. For instance, apparatus 100, sensor, and/or computing device may analyze, modify, and/or synthesize a signal representative of data in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, phase-locked loops, and/or any other process using operational amplifiers or other analog circuit elements. Continuous-time signal processing may be used, in some cases, to process signals which vary continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 1, in some embodiments apparatus 100 may include one or more light sources. As used in this disclosure, a “light source” is any device configured to emit electromagnetic radiation, such as without limitation light, UV, visible light, and/or infrared light. In some cases, a light source may include a coherent light source, which is configured to emit coherent light, for example a laser. In some cases, a light source may include a non-coherent light source configured to emit non-coherent light, for example a light emitting diode (LED). In some cases, light source may emit a light having substantially one wavelength. In some cases, light source may emit a light having a wavelength range. Light may have a wavelength in an ultraviolet range, a visible range, a near-infrared range, a mid-infrared range, and/or a far-infrared range. For example, in some cases light may have a wavelength within a range from about 100 nm to about 20 micrometers. In some cases, light may have a wavelength within a range of about 400 nm to about 2,500 nm. Light sources may include, one or more diode lasers, which may be fabricated, without limitation, as an element of an integrated circuit; diode lasers may include, without limitation, a Fabry Perot cavity laser, which may have multiple modes permitting outputting light of multiple wavelengths, a quantum dot and/or quantum well-based Fabry Perot cavity laser, an external cavity laser, a mode-locked laser such as a gain-absorber system, configured to output light of multiple wavelengths, a distributed feedback (DFB) laser, a distributed Bragg reflector (DBR) laser, an optical frequency comb, and/or a vertical cavity surface emitting laser. Light source may additionally or alternatively include a light-emitting diode (LED), an organic LED (OLED) and/or any other light emitter. In some cases, light source may be configured to couple light into optical device, for instance into one or more waveguide described above.

With continued reference to FIG. 1, in some embodiments, sensor may include at least a photodetector. In some cases, sensor device may include a plurality of photodetectors, for instance at least a first photodetector and at least a second photodetector. In some cases, at least a first photodetector and/or at least a second photodetector may be configured to measure one or more of first optical output and second optical output, from a first waveguide and a second waveguide, respectively. As used in this disclosure, a “photodetector” is any device that is sensitive to light and thereby able to detect light. In some cases, a photodetector may include a photodiode, a photoresistor, a photosensor, a photovoltaic chip, and the like. In some cases, photodetector may include a Germanium-based photodiode. Light detectors may include, without limitation, Avalanche Photodiodes (APDs), Single Photon Avalanche Diodes (SPADs), Silicon Photomultipliers (SiPMs), Photo-Multiplier Tubes (PMTs), Micro-Channel Plates (MCPs), Micro-Channel Plate Photomultiplier Tubes (MCP-PMTs), Indium gallium arsenide semiconductors (InGaAs), photodiodes, and/or photosensitive or photon-detecting circuit elements, semiconductors and/or transducers. Avalanche Photo Diodes (APDs), as used herein, are diodes (e.g., without limitation p-n, p-i-n, and others) reverse biased such that a single photon generated carrier can trigger a short, temporary “avalanche” of photocurrent on the order of milliamps or more caused by electrons being accelerated through a high field region of the diode and impact ionizing covalent bonds in the bulk material, these in turn triggering greater impact ionization of electron-hole pairs. APDs provide a built-in stage of gain through avalanche multiplication. When the reverse bias is less than the breakdown voltage, the gain of the APD is approximately linear. For silicon APDs this gain is on the order of 10-100. Material of APD may contribute to gains. Germanium APDs may detect infrared out to a wavelength of 1.7 micrometers. InGaAs may detect infrared out to a wavelength of 1.6 micrometers. Mercury Cadmium Telluride (HgCdTe) may detect infrared out to a wavelength of 14 micrometers. An APD reverse biased significantly above the breakdown voltage is referred to as a Single Photon Avalanche Diode, or SPAD. In this case the n-p electric field is sufficiently high to sustain an avalanche of current with a single photon, hence referred to as “Geiger mode.” This avalanche current rises rapidly (sub-nanosecond), such that detection of the avalanche current can be used to approximate the arrival time of the incident photon. The SPAD may be pulled below breakdown voltage once triggered in order to reset or quench the avalanche current before another photon may be detected, as while the avalanche current is active carriers from additional photons may have a negligible effect on the current in the diode. At least a first photodetector may be configured to generate a first signal as a function of variance of an optical property of the first waveguide, where the first signal may include without limitation any voltage and/or current waveform. Additionally, or alternatively, sensor device may include a second photodetector located down beam from a second waveguide. In some embodiments, second photodetector may be configured to measure a variance of an optical property of second waveguide and generate a second signal as a function of the variance of the optical property of the second waveguide.

With continued reference to FIG. 1, In some cases, photodetector may include a photosensor array, for example without limitation a one-dimensional array. Photosensor array may be configured to detect a variance in an optical property of waveguide. In some cases, first photodetector and/or second photodetector may be wavelength dependent. For instance, and without limitation, first photodetector and/or second photodetector may have a narrow range of wavelengths to which each of first photodetector and second photodetector are sensitive. As a further non-limiting example, each of first photodetector and second photodetector may be preceded by wavelength-specific optical filters such as bandpass filters and/or filter sets, or the like; in any case, a splitter may divide output from matrix multiplier and provide it to each of first photodetector and second photodetector. Alternatively, or additionally, one or more optical elements may divide output from waveguide prior to provision to each of first photodetector and second photodetector, such that each of first photodetector and second photodetector receives a distinct wavelength and/or set of wavelengths. For example, and without limitation, in some cases a wavelength demultiplexer may be disposed between waveguides and first photodetector and/or second photodetector; and the wavelength demultiplexer may be configured to separate one or more lights or light arrays dependent upon wavelength. As used in this disclosure, a “wavelength demultiplexer” is a device that is configured to separate two or more wavelengths of light from a shared optical path. In some cases, a wavelength demultiplexer may include at least a dichroic beam splitter. In some cases, a wavelength demultiplexer may include any of a hot mirror, a cold mirror, a short-pass filter, a long pass filter, a notch filter, and the like. An exemplary wavelength demultiplexer may include part No. WDM-11P from OZ Optics of Ottawa, Ontario, Canada. Further examples of demultiplexers may include, without limitation, gratings, prisms, and/or any other devices and/or components for separating light by wavelengths that may occur to persons skilled in the art upon reviewing the entirety of this disclosure. In some cases, at least a photodetector may be communicative with computing device, such that a sensed signal may be communicated with computing device.

With continued reference to FIG. 1, microfluidic device 104 may include a sensor interface. Sensor interface may be configured to wet waveguide with at least a fluid contained within or otherwise acted upon by microfluidic device 104. As used in this disclosure, a “sensor interface” is an arrangement permits sensor device to be in sensed communication with microfluidic device 104. In some embodiments, a sensor interface may include an optical interface. As used in this disclosure, an “optical interface” is an arrangement permits optical device to be in sensed communication with microfluidic device 104. In one embodiment, sensor device may be coupled to a sensor interface that includes a porous membrane (e.g., nitrocellulose, paper, glass fiber, etc.) that promotes capillary flow. In some cases, a surface of sensor device may be modified with hydrophilic chemistry, for instance by way of silanes, proteins, or another treatment (or may already be hydrophilic) in the sensing region. For example, one or more of sensor device and sensor interface may be configured such that liquid wicks from a porous membrane to a surface of sensor device as it flows through the membrane.

Still referring to FIG. 1, in some embodiments, sensor interface of microfluidic device 104 may include a flow cell. As used in this disclosure, a “flow cell” is a component of or associated with a microfluidic device that contains and provides access to a fluid or a flow of a fluid for a sensor interface arrangement. In some cases, a flow cell may effectively increase an area over which a fluid flows, thereby increasing access to the fluid for optical sensing. In some cases, a flow cell may include micro-posts. In some cases, a flow cell may include a plurality of micro-posts. As used in this disclosure, “micro-posts” are small scale (e.g., sub-millimeter) protrusions which break up a flow path. In some cases, a micro-post property may be varied in order to affect a flow property. Exemplary non-limiting micro-post properties include pitch, micro-post width (e.g., diameter), micro-post arrangement (e.g., hexagonal), micro-post size (e.g., column), micro-post height, number of micro-posts (total, in a row, in a column, etc.), and the like.

Still referring to FIG. 1, in some embodiments, sensor interface of microfluidic device 104 may include a porous membrane. As used in this disclosure, a “porous membrane” is a material with a plurality of voids. In some cases, a porous membrane may have at least a membrane property selected to achieve at least a flow property. As used in this disclosure, a “membrane property” is an objective characteristic associated with a porous membrane. Exemplary non-limiting membrane properties include pore size, porosity, measures of hydrophilicity, measures of surface tension, measures of capillary action, material, and the like. In some embodiments, a porous membrane interfacing with sensor device and microfluidic device 104 may provide several advantages. In a non-limiting example, a porous membrane connecting two segments of a channel may provide fluidic communication, connecting one segment of the channel to another; (the porous membrane may, thus, carry reagents and/or samples in solution, and open the channel to an outside environment while maintaining fluidic flow to the microfluidic device 104). In another non-limiting example, a porous membrane may eliminate need for a gasket (which may leak and result in poor yield). In a further non-limiting example, a porous membrane may help control flow properties; for instance, flow rate within microfluidic device 104 may be determined by pore size, pore density, membrane material, and porous membrane dimensions. In other non-limiting examples, a porous membrane strip interfacing sensor device to microfluidic device 104 may require less precision.

Still referring to FIG. 1, microfluidic device 104 may include at least a channel. As used in this disclosure, a “channel” is a reservoir having one or more of an inlet (i.e., input) and an outlet (i.e., output). Channels may have a submillimeter scale consistent with microfluidics. Channels may have channel properties which affect other system properties (e.g., flow properties, flow timing, and the like). As used in this disclosure, “flow timing” is any time-dependent property associated with a flow of at least a fluid. For instance, in some cases, flow timing may include a duration for a flow to reach, pass through, or otherwise interact with an element of microfluidic device 104; for instance, and without limitation, flow out from reservoir 108 of microfluidic device 104. As used in this disclosure, “channel properties” are objective characteristics associated with channels or a microfluidic device generally. Exemplary non-limiting channel properties include width, height, length, material, surface roughness, cross-sectional area, layout, and the like. In some cases, development of microfluid channel layout, selection of passive flow component, and sensor interface may need to be performed in an iterative design process as each parameter is interdependent with important system properties (e.g., flow properties and flow timing). In some embodiments, aspect ratios of chambers (e.g., reservoir 108), fluidic resistances (controlled by dimensions) of channels between the chambers (and sensor interface), and passive flow component parameters (e.g., capillary pressure of a capillary pump) may be tuned to affect one or both of timing and flow of fluid. In some embodiments, channels of microfluidic device 104 (i.e., cartridge) may be hydrophilic, for example through coating, to ensure flow. Alternatively, or additionally, microfluidic device 104 may include a hydrophilic material, such as without limitation polymethyl methacrylate (PPMA). Further, a reagent chamber may be placed such that the sensor reaction chamber is between the reagent chamber and the sample chamber.

With continued reference to FIG. 1, microfluidic device 104 includes a microfluidic circuit 112. As used in this disclosure, a “microfluidic circuit” is a configuration of a plurality of microscale fluidic components within microfluidic device 104. Microscale fluidic components may include any component and/or devices of microfluidic device 104 as described above. In a non-limiting example, microfluidic circuit 112 may include a configuration of channels, individually addressable valves, and chambers through which fluid is allowed to flow. Microfluidic device 104 with integrated sensor device may be utilized in an advanced diagnostic device or diagnostic sensor for detection of biological signatures (e.g., viruses, bacteria, pathogens, and the like). In some cases, microfluidic circuit 112 may be fabricated on a substrate. Substrate may be composed of various materials, such as glass, silicon, and the like. In one or more embodiments, microfluidic device 104 containing microfluidic circuit 112 may be fabricated using various processes, such as, for example, photolithography, injection molding, stamping processes, and the like. In various embodiments, substrate may be substantially planar. In some embodiments, components and/or devices of microfluidic device 104 may be built on a substrate using, for example, photosensitive polymers or photoresists (e.g., SU-8, Ostemer, and the like). In other embodiments, components and/or devices of microfluidic device 104 may be molded or stamped into polymers (e.g., PMMA). In other embodiments, components and/or devices of microfluidic device 104 may be built into or on substrate 204 using etching processes, in which channels, reservoir 108, capillary pumps, and valves may be built by removing materials from substrate. In non-limiting embodiments, the entire microfluidic system may be fabricated on substrate, sealed with a cover plate, where holes are drilled and aligned with certain microfluidic components, such as reservoir 108. Additionally, or alternatively, substrate may then be diced into small chips. Chips may also be fabricated with microfluidic circuit 112 etch or patterned on them. Further, they can be coupled to microfluidic circuit 112 fabricated separately on another substrate such as plastic or glass.

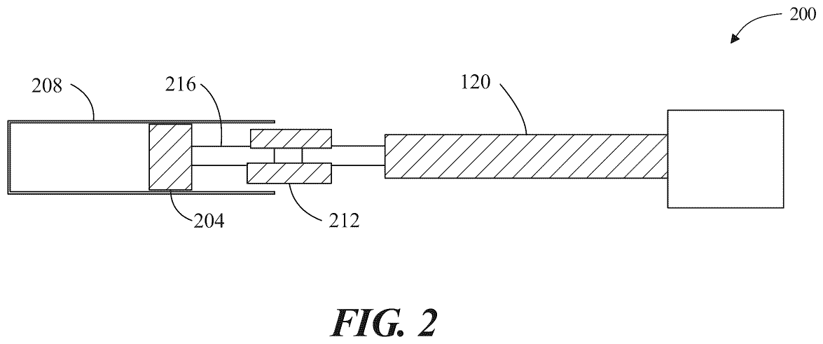

With continued reference to FIG. 1, active flow component 116 includes a barrel and a plunger at a first position within the barrel. As used in this disclosure, a “barrel” is a cylindrical container. A “plunger,” for the purpose of this disclosure, is a component which can be moved inside the barrel, letting the active flow component draw in or expel a fluid through an inlet or outlet of the active flow component. In some embodiments, barrel may include an inner diameter equal to the outer diameter of the plunger. In a non-limiting example, outer surface of plunger may be contact with inner surface of the barrel, creating a partition within the barrel. As used in this disclosure, a “first position” is a default position of the plunger within the barrel. In a non-limiting example, first position may be a position at the inlet of the active flow component. In some embodiments, active flow component with plunger may include a sealing mechanism. As used in this disclosure, a “sealing mechanism” is a system configured to create a pressure difference between two different areas in active flow component. In a non-limiting example, sealing mechanism may enable active flow component to create the partition within the barrel with a first pressure different than a second pressure outside the barrel and/or active flow component, wherein the first pressure may be smaller than the second pressure. Active flow component may be described in greater detail below in reference to FIG. 2.

With continued reference to FIG. 1, apparatus includes an actuator 120. As used in this disclosure, an “actuator” is a device that produces a motion by converting energy and signals going into the system. In some cases, motion may include linear, rotatory, or oscillatory motion. Actuator 120 may include a component of a machine that is responsible for moving and/or controlling a mechanism or system. Actuator 120 may, in some cases, require a control signal and/or a source of energy or power. In some cases, a control signal may be relatively low energy. Exemplary control signal forms include electric potential or current, pneumatic pressure or flow, or hydraulic fluid pressure or flow, mechanical force/torque or velocity, or even human power. In some cases, an actuator may have an energy or power source other than control signal. This may include a main energy source, which may include for example electric power, hydraulic power, pneumatic power, mechanical power, and the like. In some cases, upon receiving a control signal, actuator 120 responds by converting source power into mechanical motion. In some cases, an actuator 120 may be understood as a form of automation or automatic control. Additionally, or alternatively, actuator 120 may include a housing 124. As used in this disclosure, a “housing” is a casing that encloses one or more components of apparatus 100. In a non-limiting example, housing 124 may include a rigid casing that encloses actuator 120. Housing may protect actuator 120 from damage. In some cases, active flow component 116 may also be enclosed by housing 124.

With continued reference to FIG. 1, in some embodiments, actuator 120 may include a hydraulic actuator. A hydraulic actuator may consist of a cylinder or fluid motor that uses hydraulic power to facilitate mechanical operation. Output of hydraulic actuator 120 may include mechanical motion as described above. In some cases, hydraulic actuator may employ a liquid hydraulic fluid. As liquids, in some cases, are incompressible, a hydraulic actuator can exert large forces. Additionally, as force is equal to pressure multiplied by area, hydraulic actuators may act as force transformers with changes in area (e.g., cross sectional area of cylinder and/or piston). An exemplary hydraulic cylinder may consist of a hollow cylindrical tube within which a piston can slide. In some cases, a hydraulic cylinder may be considered single acting. Single acting may be used when fluid pressure is applied substantially to just one side of a piston. Consequently, a single acting piston can move in only one direction. In some cases, a spring may be used to give a single acting piston a return stroke. In some cases, a hydraulic cylinder may be double acting. Double acting may be used when pressure is applied substantially on each side of a piston; any difference in resultant force between the two sides of the piston causes the piston to move.

With continued reference to FIG. 1, in some embodiments, actuator 120 may include a pneumatic actuator. In some cases, a pneumatic actuator may enable considerable forces to be produced from relatively small changes in gas pressure. In some cases, a pneumatic actuator may respond more quickly than other types of actuators, for example hydraulic actuators. A pneumatic actuator may use compressible fluid (e.g., air). In some cases, a pneumatic actuator may operate on compressed air. Operation of hydraulic and/or pneumatic actuators may include control of one or more valves, circuits, fluid pumps, and/or fluid manifolds.

With continued reference to FIG. 1, in some cases, actuator 120 may include an electric actuator. Electric actuator may include any of electromechanical actuators, linear motors, and the like. In some cases, actuator 120 may include an electromechanical actuator. An electromechanical actuator may convert a rotational force of an electric rotary motor into a linear movement to generate a linear movement through a mechanism. Exemplary mechanisms, include rotational to translational motion transformers, such as without limitation a belt, a screw, a crank, a cam, a linkage, a scotch yoke, and the like. In some cases, control of an electromechanical actuator may include control of electric motor, for instance a control signal may control one or more electric motor parameters to control electromechanical actuator. Exemplary non-limitation electric motor parameters include rotational position, input torque, velocity, current, and potential, electric actuator 120 may include a linear motor. Linear motors may differ from electromechanical actuators, as power from linear motors is output directly as translational motion, rather than output as rotational motion and converted to translational motion. In some cases, a linear motor may cause lower friction losses than other devices. Linear motors may be further specified into at least 3 different categories, including flat linear motor, U-channel linear motors and tubular linear motors. Linear motors may be directly controlled by a control signal for controlling one or more linear motor parameters. Exemplary linear motor parameters include without limitation position, force, velocity, potential, and current.

With continued reference to FIG. 1, in some embodiments, actuator 120 may include a mechanical actuator. In some cases, a mechanical actuator may function to execute movement by converting one kind of motion, such as rotary motion, into another kind, such as linear motion. An exemplary mechanical actuator includes a rack and pinion. In some cases, a mechanical power source, such as a power take off may serve as power source for a mechanical actuator. Mechanical actuators may employ any number of mechanism, including for example without limitation gears, rails, pulleys, cables, linkages, and the like. In a non-limiting example, actuator 120 may include a linear actuator. As used in this disclosure, a “linear actuator” is an actuator that creates linear motion. Linear actuator may create motion in a straight line. In some cases, active flow component 116 may be aligned with the straight line.

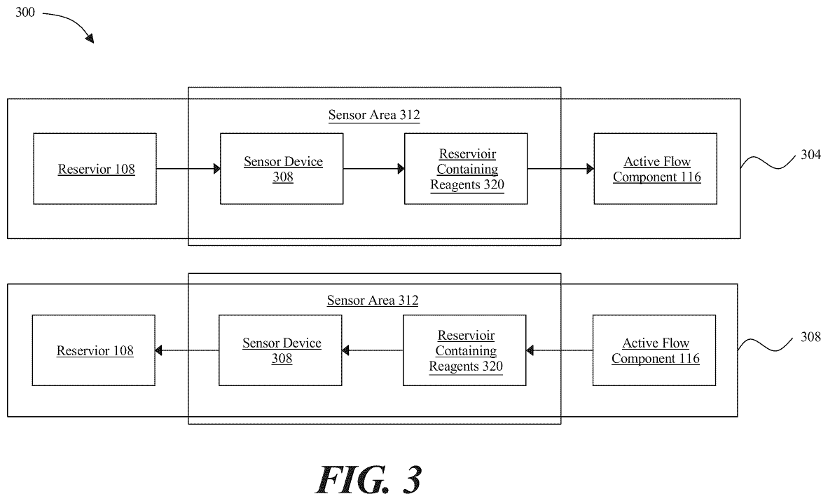

Now referring to FIG. 2, a general functionality 200 of plunger 204 moved within barrel 208 by an actuator 120 contained in an assembly that interfaces with microfluidic device 104 is illustrated. Actuator 120 is configured to initiate an active flow process as a function of active flow component 116. As used in this disclosure, an “active flow process” is a plurality of actions or steps taken on active flow component in order to impart active flow on at least a fluid contained within or otherwise acted upon by microfluidic device 104. Active flow process may be described in further detail below in reference to FIG. 3. Initiating active flow process includes accepting plunger 204 using a mechanical interface 212 mechanically communicated to the actuator. As used in this disclosure, “accepting” means griping, holding, or otherwise accepting a component and/or a device such as, without limitation, plunger 204. A “mechanical interface,” for the purpose of this disclosure, is a component configured to connect at least two components. In a non-limiting example, plunger 204 may include a shaft 216. As used in this disclosure, a “shaft” is a part or section forming a handle of plunger 204. Shaft 216 may be attached to one end of plunger 204. Accepting plunger 204 may include griping shaft 216 attached to the plunger 204 using mechanical interface 212. In some embodiments, mechanical interface 212 between plunger 204 and actuator 120 may be a friction fit, an interference fit, or a snap fit, wherein shaft 216 has a male or female adapter and the actuator 120 contains a female or male adapter. For example, when the male (female) adapter engages with the female (male) adapter a mechanical connection is established. This mechanical connection can be designed so that it automatically disengages when a certain level of force is applied. Alternatively, it can be designed so that a mechanical input is necessary to cause the male and female connectors to disengage. In some embodiments, this mechanical coupling between plunger 204 and actuator 120 may be accomplished by other means (e.g., a Janney coupler, knuckle coupler, etc.). In other embodiments, mechanical coupling between the plunger and a linear actuator may be accomplished by a magnet or multiple magnets.

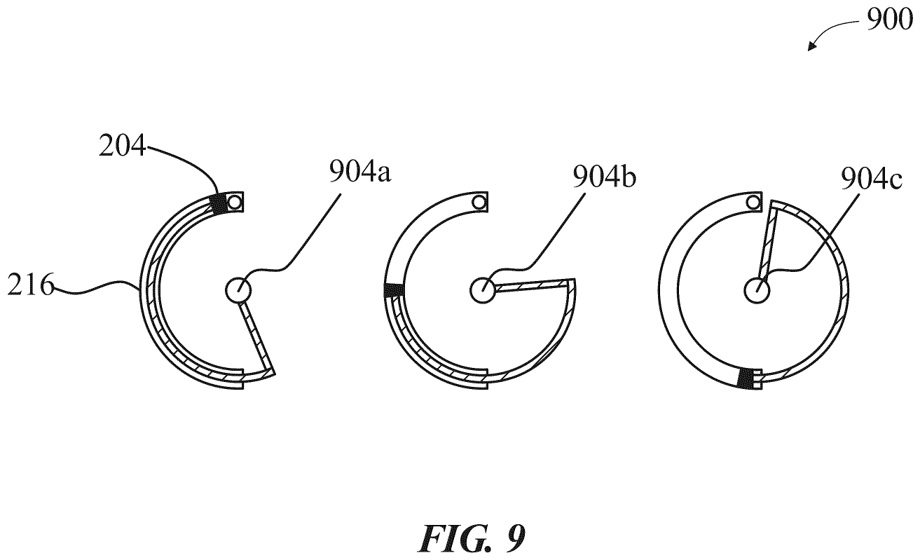

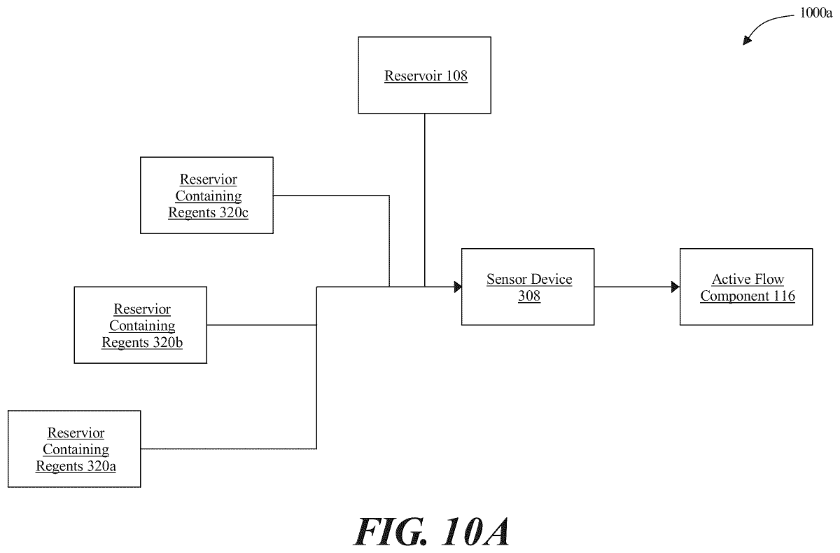

With continued reference to FIG. 2, in some embodiments, shaft 216 may be configured to transmit power from one component such as, without limitation, actuator 120, to attached plunger 204. In a non-limiting example, initiating active flow process includes moving plunger 204 within barrel 208 from first position to a second position based on predetermined flow properties. In some embodiments, moving plunger 204 within the barrel 208 may include moving plunger 204 within the barrel 208 as a function of power (i.e., force, motion, and the like) transmitted by shaft 216 from actuator 120; for instance, and without limitation, actuator 120 may include a linear actuator, wherein the linear actuator may output a linear motion to mechanical interface 212, which is further transmitted to plunger 204 via shaft 216 connected to mechanical interface 212. In a non-limiting example, moving plunger 204 within barrel 208 from first position to second position may include moving an extension tube along a spindle (i.e., lead screw) within actuator 120 from a first position of the spindle to a second position of the spindle. Second position may refer to as a “set point” on the spindle of actuator 120. Set point/second position may be determined as a function of flow properties. Flow properties may include any flow properties described above in this disclosure, in a non-limiting example, set point/second position may be determined as a function of the desired flow volume (in μl). Active flow component 116 may draw and/or expel greater amount of fluid as set point/second position moves further away from first position. Actuator 120 is then configured to flow the at least a fluid unidirectionally as a function of the active flow process. Actuation of plunger 204 directly causes the unidirectional movement of at least a fluid through a microfluidic circuit 112 within microfluidic device 104 which may contain one or more fluidic channels. Additionally, or alternatively, plunger 204 may be contained within barrel 208 that is configured in a circle. Plunger 204 may be actuated via rotation about the center of the circle. Such embodiment may be described in further detail below in reference to FIG. 9.

Now referring to FIG. 3, a bi-directional flow for a general two-step assay 300 is illustrated. In some embodiments, active flow process may include a reverse flow process 304. As used in this disclosure, a “reverse flow process” is an active flow process in a reverse direction, wherein the reverse direction is defined as a direction of at least a fluid out of reservoir 108 of microfluid device 104. In a non-limiting example, reverse flow process 304 may be initiated, by actuator 120, as a function of the movement of plunger 204 within barrel 208 from first position to second position in reverse direction (i.e., the direction towards second position). In other embodiments, active flow process may include a forward flow process 308. As used in this disclosure, a “forward flow process” is an active flow process in a forward direction, wherein the forward direction is defined as a direction of at least a fluid into reservoir 108 of microfluid device 104. In a non-limiting example, forward flow process 308 may be initiated, by actuator 120, as a function of the movement of plunger 204 within barrel 208 from second position back to first position in forward direction (i.e., the direction towards first position).

With continued reference to FIG. 3, flowing at least a fluid may include flowing at least a fluid through a sensor area 312, wherein sensor area 312 may include at least a sensor device 316 and at least a sensor interface. Sensor device 316 may include any sensor device described above in reference to FIG. 1, such as, without limitation, sensor, optical device, and the like. Sensor interface may include any sensor interface as described above in reference to FIG. 1. In some embodiments, sensor interface may include a reservoir containing reagents 320. In a non-limiting example, sensor interface may include porous membrane carrying reagents and/or samples in solution as described above. In a non-limiting example, flow at least a fluid as a function of active flow process may include flow at least a fluid as a function of reverse flow process 304. During reverse flow process 304, actuator may configure active flow component 116, more specifically, plunger 204 within barrel 208, to move from the default position to a determined second position. Such actuation may cause at least a fluid within reservoir 108 to flow from reservoir 108 to sensor area 312 and further to active flow component 116. At least a fluid may be stored within the partition within barrel 208 formed by plunger 204. In another non-limiting example, flow at least a fluid as a function of active flow process may further include flow at least a fluid as a function of forward flow process 308. During forward flow process 308, actuator may configure active flow component 116, more specifically, plunger 204 within barrel 208, to move from the second position back to first position. Such actuation may cause at least a fluid within the partition within barrel 208 formed by plunger 204 to flow towards sensor area 312, back to reservoir 108. Sensor area may be configured to detect at least a sensed property; for instance, and without limitation, method for detecting at least a sensed property may be consistent with any method for detecting sensed property described in U.S. patent application Ser. No. 17/859,932. Forward flow process 308 may be described in further detail below.

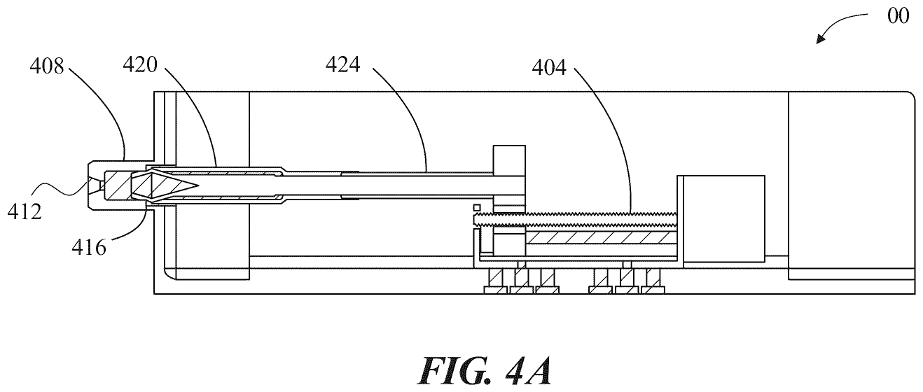

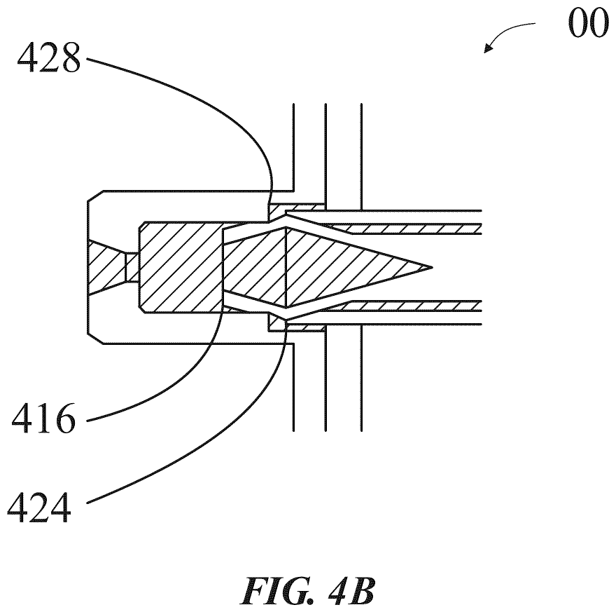

Now referring to FIG. 4A, a cross-sectional view of an exemplary embodiment 400 of plunger 204 containing a feature that allows it to interface with a linear actuator 404, constrained within barrel 208 is illustrated. In some embodiments, linear actuator 404 may produce motion in a straight line, wherein the straight line may be horizontal. In such embodiments, active flow component 116 may be oriented according the straight line; for instance, and without limitation, barrel 208 and plunger 204 within active flow component 116 may be disposed horizontally and aligned with the lead screw of the linear actuator 404. In a non-limiting example, the placement of active flow component 116 may be parallel to the lead screw of linear actuator 404.

With continued reference to FIG. 4A, linear actuator 404 may be enclosed in a housing 408. Housing 408 may include any housing as described above. In an embodiment, linear actuator 404 may be partially enclosed in housing 408. In a non-limiting example, housing 408 may include a bore 412 configured to accept plunger 204 as described above. Bore 412 may be located at one end of housing 408. Alternatively, or additionally, bore 412 may protrude from the surface of housing 408.

With continued reference to FIG. 4A, in some embodiments, mechanical interface 212 may include an expandable claw 416. As used in this disclosure, an “expandable claw” is a component configured to catch and/or hold another component with an acceptable width of height. In some embodiments, expandable claw 416 may include an upper jaw and a lower jaw, wherein the upper jaw is an upper half portion of expandable claw 416 and the lower jaw is a lower half portion of expandable jaw 416. In some embodiments, accepting plunger 204 may include opening the expandable claw 416. Opening expandable claw 416 may include moving upper jaw or lower jaw away from lower jaw or upper jaw. Accepting plunger 204 may further include closing expandable claw 416. Closing expandable claw 416 may include moving upper jaw or lower jaw towards lower jaw or upper jaw. In some embodiments, closing expandable claw 416 may include moving upper jaw and lower jaw towards upper surface and lower surface of shaft 216 connected to plunger 204; for instance, and without limitation, closing expandable claw 416 may include contacting shaft 216 connected to plunger 204. Therefore, plunger 204 may be accepted by expandable claw 416 (i.e., mechanical interface 212) as a function of a static feature, wherein the static feature may include friction formed by the contact of expandable claw 416 and shaft 216. Alternatively, or additionally, plunger 204 may be gripped by retractable balls embedded within bore 412.

With continued reference to FIG. 4A, mechanical interface 212 may further include a collar 420 configured to constraint expandable claw 416. As used in this disclosure, a “collar” is a ring-shaped device that clamps around shaft 216. In some cases, collar 420 may be made of plastic or metal. In some embodiments, collar 420 may be configured to hold component, such as, without limitation, expandable claw 416, to facilitate and/or regulate its proper movement. In a non-limiting example, expandable claw 416 may be held closed by collar 420 which is preloaded by a spring 424 or by other means at its initial state. The expandable jaws may be allowed to open by retracting the collar 420 in a direction towards linear actuator 404. This may occur automatically when the linear actuator 404 reaches a set point in its travel and a feature on the moving collar 420 makes contact with a static feature (i.e., surface) of housing 408. Linear actuator 404 may be configured to initiate forward active flow process 308 as described above when plunger 204 contacts spring 424 as plunger 204 moves within barrel 208 from first position to second position.

Now referring to FIG. 4B, a detailed cross-sectional view of embodiment 400 highlighting expandable claw 416 is illustrated. In some embodiments, when a collar face 424 contacts the housing face 438, it is pushed back against spring 420 (not shown in FIG. 4B), therefore allowing the expandable jaws to open and accept plunger 204 and/or shaft 216 connected to plunger 204. As used in this disclosure, a “collar face” is an edge of collar 420, and a “housing face” is an edge of housing 408.

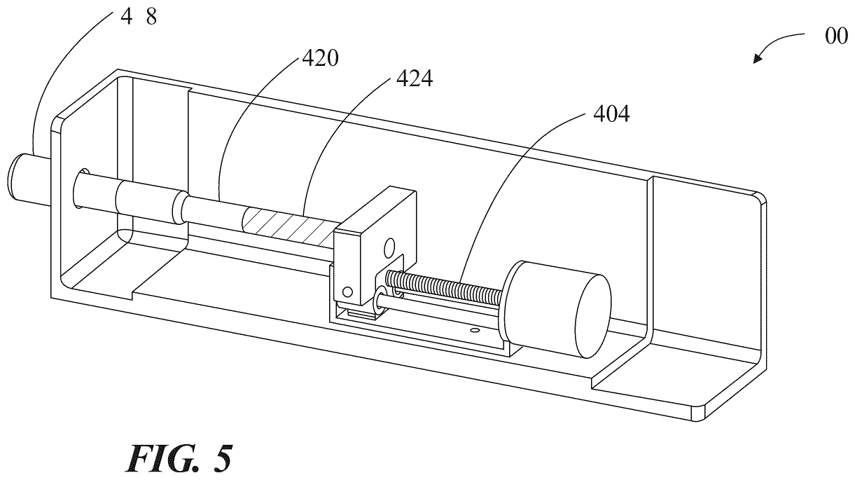

Now referring to FIG. 5, a three-dimensional view of exemplary embodiment 400 is illustrated. Apparatus 100 may include a linear actuator 404 enclosed by housing 404, wherein the linear actuator 404 may interface with plunger 204 containing constrained within barrel 208 via mechanical interface 212. Mechanical interface 212 may include collar 420 surround expandable claw 416, configured to constrain expandable claw 416, and a spring 424 configured to affect active flow process. In some embodiments, the process of inserting the cartridge (i.e., microfluidic device 104) into housing 408 may cause shaft 216 of plunger 204 to be inserted into expandable claw 216. In a non-limiting example, when assay is to begin, linear actuator 404 may retract past a set point, causing upper jaw and lower jaw of expandable claw 416 to move inward and grip shaft 216 connected to plunger 204. When linear actuator 404 returns to the set point, upper jaw and lower jaw may be automatically actuated, allowing cartridge to be easily removed. In some cases, texture may be added to the inside surface of both upper jaw and lower jaw, and/or to shaft 216 connected to plunger 204 to increase the pulling or pull-out force necessary to dislodge shaft 216 from linear actuator 404.

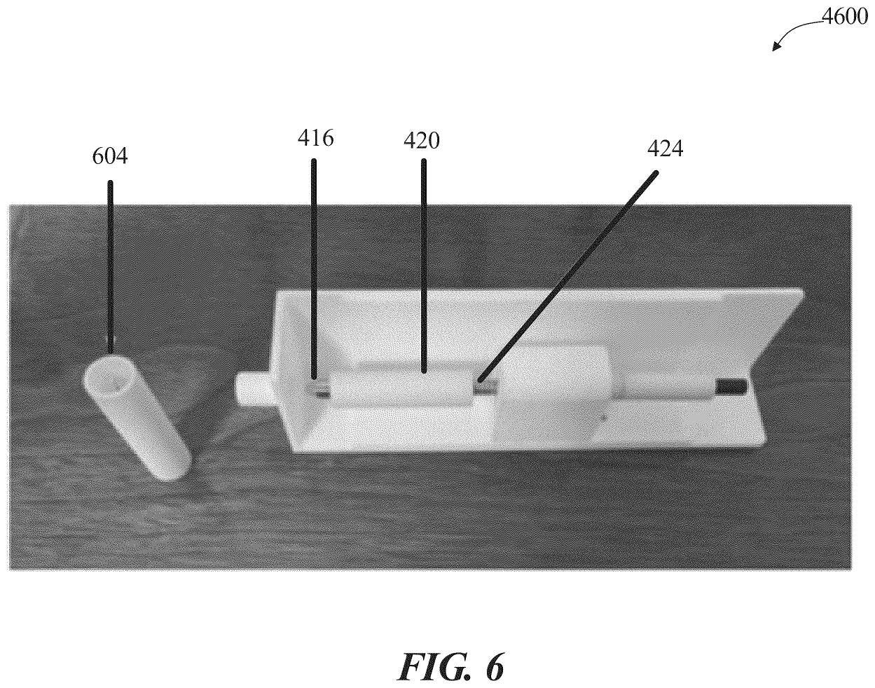

Now referring to FIG. 6, a prototype 600 of the exemplary embodiment 400 is shown. Prototype 600 may feature a syringe 604, expandable claw 416, collet collar 420, and spring 424.

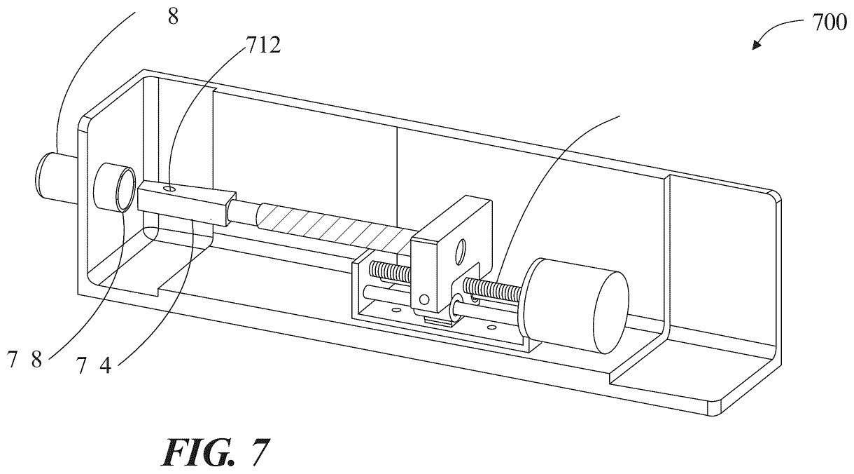

Now referring to FIG. 7, an exemplary embodiment 700 of plunger 204 is illustrated. In some embodiments, shaft 208 connected to plunger 204 may be gripped by a multi-jaw clip, such as an alligator clip 704, which is attached to linear actuator 404. As used in this disclosure, an “alligator clip” is a plier-like spring-tensioned clip with elongated, serrated upper jaw and lower jaw. In some cases, the upper jaw and lower jaw may open automatically in a similar manner compared to embodiment 400 as described above, such as, without limitation, when linear actuator 404 reaches a set point in its travel and the jaws make contact with a static feature on housing 408, such as a cylindrical hole 708 of sufficiently small diameter (i.e., diameter smaller than the rear width of alligator clip 704). In such embodiment, the jaws may be forced open by pinching the rear ends of the jaws together, causing preloaded spring to compress and creating a rotation about the pivot joint 712. Jaws opening may be caused by alligator clip 704 entering cylindrical hole 708 of sufficiently small dimensions to cause the arms of the clip to move inward upon entering cylindrical hole 708. Expanding jaws of alligator clip 704 allows linear actuator 404 to accept plunger 204. The process of inserting cartridge (i.e., microfluidic device 104) into housing 408 may also cause shaft 216 connected to plunger 204 to be inserted into the expandable jaws of alligator clip 704. In a non-limiting example, when the test begins, linear actuator 404 may retract past set point, causing expandable jaws of alligator clip 704 to move inward and grip shaft 216 connected to plunger 204. When linear actuator 404 returns to set point, expandable jaws may be automatically opened, allowing cartridge to be easily removed.

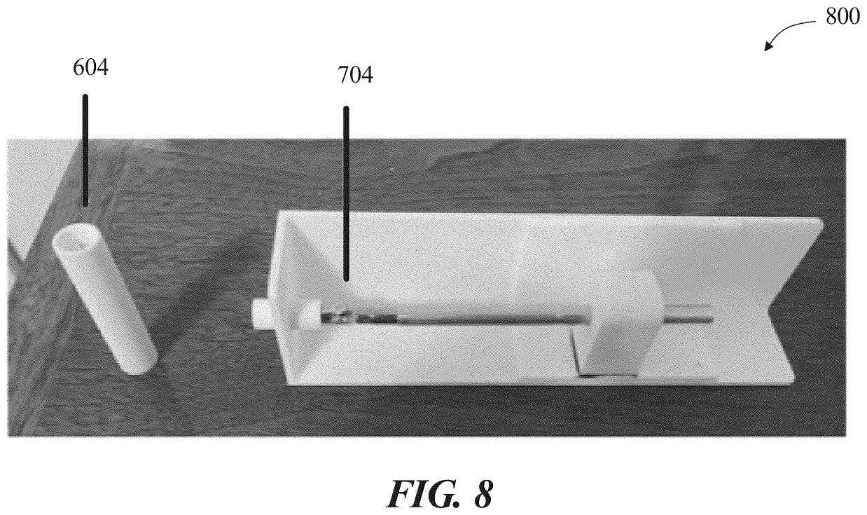

Now referring to FIG. 8, a porotype 800 utilizing alligator clip 704 to grip shaft 216 is illustrated. In some embodiments, at the initial state, upper jaw and lower jaw of alligator clip 704 may be held closed by the spring embedded within alligator clip 704.

Now referring to FIG. 9, an example of rotary actuation 900 of plunger 204 is illustrated. In some embodiments, plunger 204 may be contained within a circular tube, wherein the circular tube may be shaft 216 as described above. In some embodiments, plunger 204 may be linked mechanically to a hub 904a-c. As used in this disclosure, a “hub” is a rotary component located on a central axis of the circular tube (i.e., shaft 216). In some embodiments, hub 904a-c may allow plunger 204 to be actuated by a rotation. Such rotation may be affected by a rotary actuator, such as a motor, which is contained within independent housing 408 as described above. In a non-limiting example, at initial state, hub 904a may be at a first position. Active flow component 116 with hub 904a may flow and/or accept 0 μl of at least a fluid from reservoir 108. Continuing the non-limiting example, hub 904a may be moved, by rotary actuator, to a second position (i.e., hub 904b). Active flow component 116 with hub 904b may flow and/or accept 50 μl of at least a fluid from reservoir 108. Further continuing the non-limiting example, hub 904b may be moved, by rotary actuator, to a third position (i.e., hub 904c). Active flow component 116 with hub 904c may flow and/or accept 100 μl of at least a fluid from reservoir 108. Additionally, or alternatively, at least a fluid may be actuated pneumatically. In such embodiment, active flow component 116 may include a pneumatic pump contained within housing 408 that may interface with cartridge (i.e., microfluidic device 104). A liquid barrier or membrane may be used to ensure that at least a fluid within reservoir 108 of cartridge does not leak or pass into housing 408.

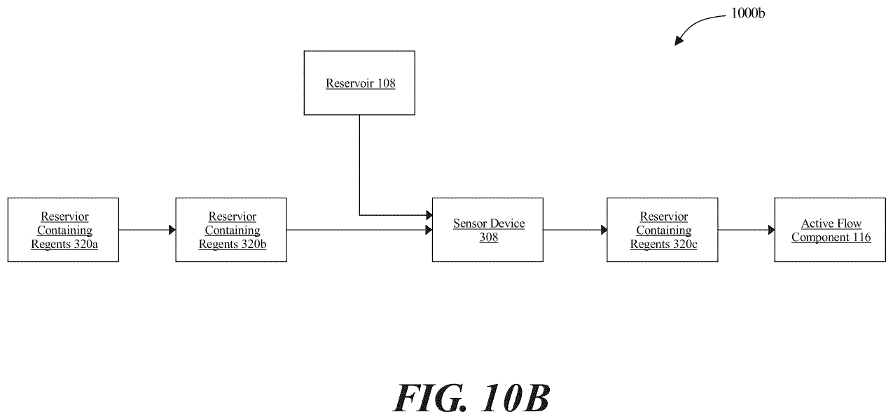

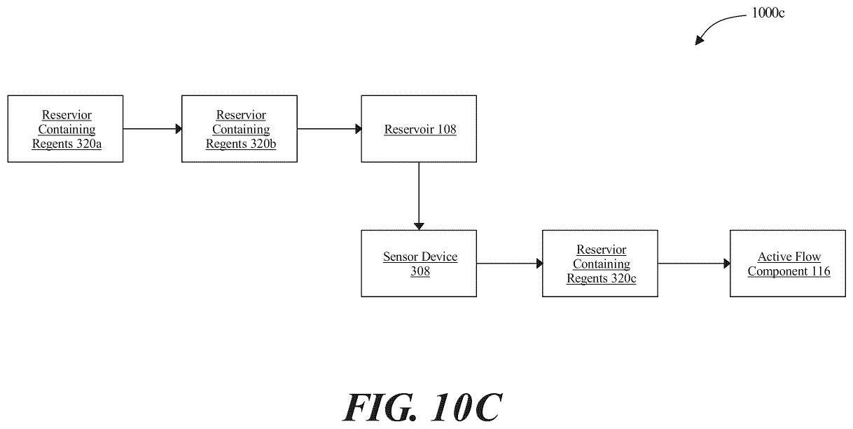

Now referring to FIG. 10A-C, block diagrams of various methods 1000a-c for multi-step assay are illustrated. As used in this disclosure, a “multi-step assay” is an immunoassay which can be carried out by mixing reagents and sample and making one or more physical measurement. In some embodiments, embodiments described above in this disclosure may permit methods for performing multi-step assays. In a non-limiting example, “multi-step assay” may include a multiplex assay.

Now referring to FIG. 10A, block diagram of an exemplary method 1000a of varies methods for multi-step assay is illustrated. Method 1000a may be affected by the presence of multiple lyophilized reagents (i.e., reservoir containing regents 320a-c) in separate branches of microfluidic circuit 112, downstream of sensor device 308. In some embodiments, sensor device 308 may include diagnostic sensor as described above. If each of these path lengths are significantly different, a flow reversal (i.e., reverse flow process 304) may cause the dissolved reagents to return in series rather than simultaneously.

Now referring to FIGS. 10B and 10C, block diagrams of exemplary methods 1000b-c of varies methods for multi-step assay are illustrated. In some embodiments, multiple reagents (i.e., reservoir containing regents 320a-c) may be stored upstream and downstream of the sensor device 308 in a single flow path. In some embodiments, sensor device 308 may include diagnostic sensor as described above. In these cases, controlling the amount of at least a fluid volume that is moved by active flow component 116 may control how and when at least a fluid flow reaches other system components (e.g., reservoir containing regents 320a-c). For example, when the flow is reversed (i.e., reverse flow process 304 is initiated), the reagents have been reached by at least a fluid will then be able to flow over diagnostic sensor. In other embodiments, a combination of passive flow component and active flow component 116 may be used to affect multi-step assays. Membranes that require a certain threshold of pressure before flow may be able to pass through them may also be used for this effect.

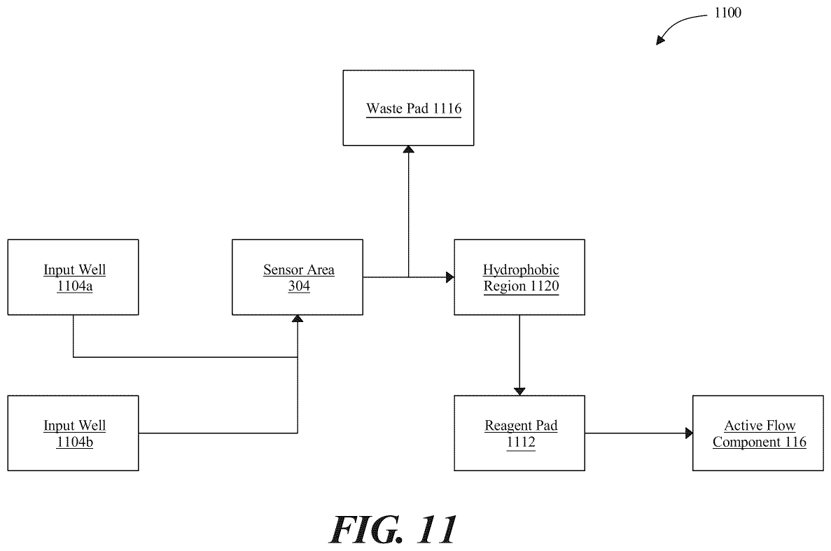

Now referring to FIG. 11, a block diagram 1100 of performing multi assay steps using two input wells 1104a-b on the same cartridge (i.e., microfluidic device 104). In a non-limiting example, a user may first place a sample fluid (e.g., a drop of blood) into first input well 1104a. This wicks onto sensor area 304 via a microfluidic or porous hydrophilic channel (i.e., picking up reagent/and or being filtered as it enters microfluidic device 104, either from a reagent pad 1112 or another surface). User may then close input well 1104a with a cap creating a pressure to drive sample fluid. The flow may then continue for some time wicking past sensor area 304 into a waste area. Sensor area 304 may include sensor device 308 and sensor interface 312 as described above in reference to FIG. 3. User in the meantime may have added a buffer or second sample fluid to input well 1104b. User may then notify the instrument via software, a physical button, computing device, by plugging in microfluidic device 104, and the like. In some embodiments, instrument may automatically estimate the time or use sensor area 304 to record when first sample fluid has started flowing, and the instrument starts to retract plunger 204 which pulls second sample fluid/buffer over sensor device 308 and or sensor interface 312. The first fluid sample may be stored in a dead-end waste area (e.g., waste pad 1116) that has high capillary pull and so only the buffer/second fluid sample may be pulled into active flow component 116 such as, without limitation, a syringe. Second fluid sample may pick up some dried reagents before and/or after sensor area 304 and then by reversing plunger 204 the instrument can send now solubilized reagent back over sensor area 304. This sequence may enable, in one example, a wash step and a detection step after an initial binding step.

With continued reference to FIG. 11, to prevent air from getting into the system from input well 1104a, a capillary stop valve may be used preventing the last of the liquid in input well 1104a from being pulled through by active flow component 116. A hydrophobic region 1120 or widened channel may be added after the waste pad 1116 to prevent any of first fluid sample traveling past it to the reagent pad 1112 and active flow component 116 by capillary action. Hydrophobic region 1120 or widened channel may be added between sensor area 304 and the input well 1104b to prevent any of first fluid sample traveling past it to input well 110b by capillary action. Alternatively, or additionally, user or the instrument may plug the first input at some point in the process.

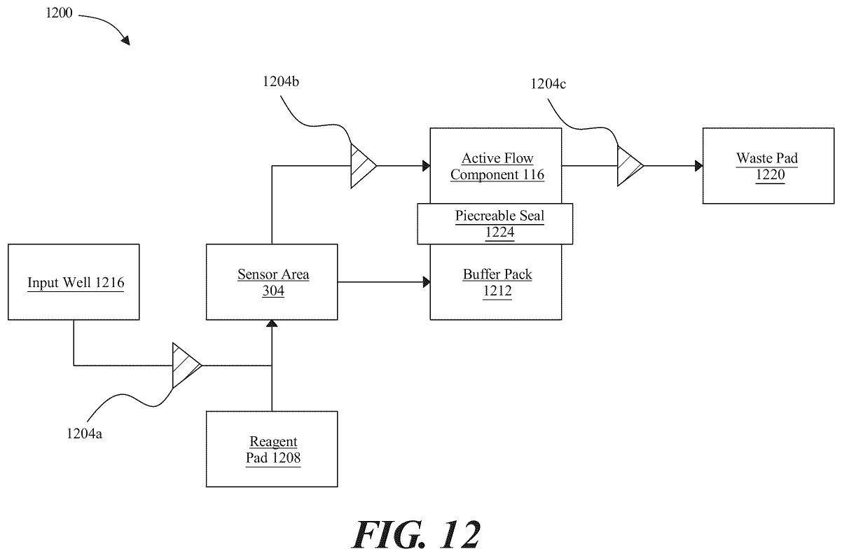

Now referring to FIG. 12, a block diagram of how active flow component may be used in a multistep workflow in cartridge utilizing a pierceable seal is illustrated. In some embodiments, Active flow component 116 such as, without limitation, a syringe may be used in combination with microfluidic channels, passive or active valves 1204a-b, and blister packs (i.e., buffer pack 1208), reagent pads/beads 1212 to create a multistep workflow in the cartridge (i.e., microfluidic device 104). In some cases, there may be a single input well 1216. After user adds sample fluid, the instrument pulls syringe back which causes sample fluid to flow over sensor area 304. The sample fluid then fills syringe through a one-way valve 1204b. Once sample fluid is in syringe, plunger 204 may reverse, pushing sample fluid out of a secondary one-way valve 1204c to a waste pad 1220. Plunger 204 may then hit a hard stop at its original starting position; however, this hard stop may be a pierceable blister pack (i.e., buffer pack 1208 with a pierceable seal 1224) or foil seal that plunger 204 then pierces which may force the liquid in the chamber over sensor area 304. That liquid may pick up lyophilized or dried reagents before or after sensor area 304 and it may be pulled back over sensor area 304 again by reversing plunger 204 to add an additional assay step using reagents picked up from the reagent chamber/pad/bead 1212 after the sensor area 304. In some cases, the reagent pad 1212 is vented in order to allow forward flow in that channel via an actuation caused by plunger 204 (i.e., forward flow process 308) that happens in coordination with piercing of the seal. The plunger may be quickly actuated back and forth to encourage mixing.

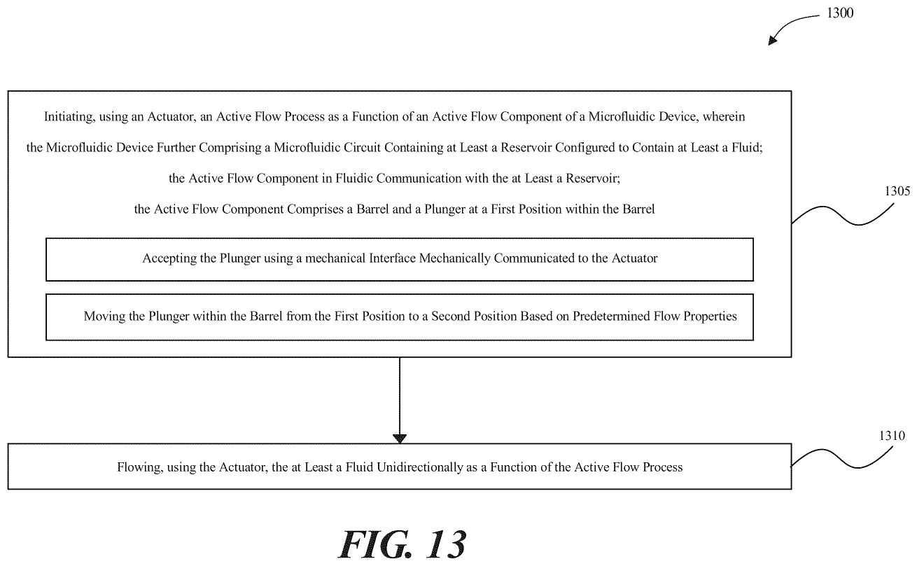

Now referring to FIG. 13, a flow diagram of an exemplary embodiment of method 1300 for actuating fluids in a biosensing cartridge is illustrated. Method 1300 includes a step 1305 of initiating, using an actuator, an active flow process as a function of an active flow component of a microfluidic device, wherein the microfluidic device further including a microfluidic circuit containing at least a reservoir configured to contain at least a fluid, the active flow component in fluidic communication with the at least a reservoir, the active flow component includes a barrel and a plunger at a first position within the barrel, and initiating the active flow process includes accepting the plunger using a mechanical interface mechanically communicated to the actuator and moving the plunger within the barrel from the first position to a second position based on predetermined flow properties. This may be implemented, without limitation, as described above in reference to FIGS. 1-12. In some embodiments, the plunger may include a shaft. In some embodiments, the actuator may include a linear actuator. In some embodiments, the actuator may include a housing. In some embodiments, the mechanical interface may include an expandable claw and a collar configured to constraint the expandable claw. In some embodiments, the collar may be preloaded by a spring. This may be implemented, without limitation, as described above in reference to FIGS. 1-12.

With continued reference to FIG. 13, method 1300 includes a step 1310 of flowing, using the actuator, the at least a fluid unidirectionally as a function of the active flow process. This may be implemented, without limitation, as described above in reference to FIGS. 1-12. In some embodiments, the active flow process may include a reverse flow process and a forward flow process. In some embodiments, flowing the at least a fluid may include flowing the at least a fluid through a sensor area, wherein the sensor area may include at least a sensor device and at least a sensor interface. In some embodiments, the actuator may be further configured to initiate the forward active flow process when the plunger contacts the spring as the plunger moves within the barrel from the first position to the second position. In some embodiments, initiating the forward active flow process may include moving the plunger within the barrel from the second position back to the first position.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

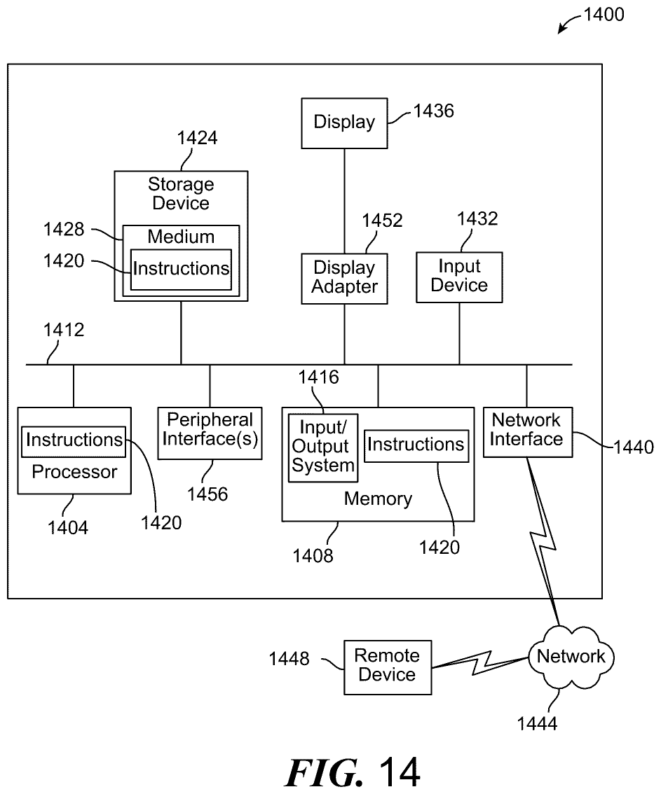

FIG. 14 shows a diagrammatic representation of one embodiment of a computing device in the exemplary form of a computer system 1400 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1400 includes a processor 1404 and a memory 1408 that communicate with each other, and with other components, via a bus 1412. Bus 1412 may include any of several types of bus structures including, but not limited to, a memory bus, a memory controller, a peripheral bus, a local bus, and any combinations thereof, using any of a variety of bus architectures.

Processor 1404 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1404 may be organized according to Von Neumann and/or Harvard architecture as a non-limiting example. Processor 1404 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1408 may include various components (e.g., machine-readable media) including, but not limited to, a random-access memory component, a read only component, and any combinations thereof. In one example, a basic input/output system 1416 (BIOS), including basic routines that help to transfer information between elements within computer system 1400, such as during start-up, may be stored in memory 1408. Memory 1408 may also include (e.g., stored on one or more machine-readable media) instructions (e.g., software) 1420 embodying any one or more of the aspects and/or methodologies of the present disclosure. In another example, memory 1408 may further include any number of program modules including, but not limited to, an operating system, one or more application programs, other program modules, program data, and any combinations thereof.

Computer system 1400 may also include a storage device 1424. Examples of a storage device (e.g., storage device 1424) include, but are not limited to, a hard disk drive, a magnetic disk drive, an optical disc drive in combination with an optical medium, a solid-state memory device, and any combinations thereof. Storage device 1424 may be connected to bus 1412 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1424 (or one or more components thereof) may be removably interfaced with computer system 1400 (e.g., via an external port connector (not shown)). Particularly, storage device 1424 and an associated machine-readable medium 1428 may provide nonvolatile and/or volatile storage of machine-readable instructions, data structures, program modules, and/or other data for computer system 1400. In one example, software 1420 may reside, completely or partially, within machine-readable medium 1428. In another example, software 1420 may reside, completely or partially, within processor 1404.

Computer system 1400 may also include an input device 1432. In one example, a user of computer system 1400 may enter commands and/or other information into computer system 1400 via input device 1432. Examples of an input device 1432 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1432 may be interfaced to bus 1412 via any of a variety of interfaces (not shown) including, but not limited to, a serial interface, a parallel interface, a game port, a USB interface, a FIREWIRE interface, a direct interface to bus 1412, and any combinations thereof. Input device 1432 may include a touch screen interface that may be a part of or separate from display 1436, discussed further below. Input device 1432 may be utilized as a user selection device for selecting one or more graphical representations in a graphical interface as described above.

A user may also input commands and/or other information to computer system 1400 via storage device 1424 (e.g., a removable disk drive, a flash drive, etc.) and/or network interface device 1440. A network interface device, such as network interface device 1440, may be utilized for connecting computer system 1400 to one or more of a variety of networks, such as network 1444, and one or more remote devices 1448 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1444, may employ a wired and/or a wireless mode of communication. In general, any network topology may be used. Information (e.g., data, software 1420, etc.) may be communicated to and/or from computer system 1400 via network interface device 1440.

Computer system 1400 may further include a video display adapter 1452 for communicating a displayable image to a display device, such as display device 1436. Examples of a display device include, but are not limited to, a liquid crystal display (LCD), a cathode ray tube (CRT), a plasma display, a light emitting diode (LED) display, and any combinations thereof. Display adapter 1452 and display device 1436 may be utilized in combination with processor 1404 to provide graphical representations of aspects of the present disclosure. In addition to a display device, computer system 1400 may include one or more other peripheral output devices including, but not limited to, an audio speaker, a printer, and any combinations thereof. Such peripheral output devices may be connected to bus 1412 via a peripheral interface 1456. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. An apparatus for actuating of fluids in a biosensor cartridge, the apparatus comprises:
a microfluidic device, wherein the microfluidic device comprises:
a microfluidic circuit comprising at least a reservoir configured to contain at least a fluid; and
an active flow component in fluidic communication with the at least a reservoir, wherein the active flow component comprises:
a barrel; and
a plunger at a first position within the barrel; and
an actuator configured to:
initiate an active flow process as a function of the active flow component, wherein initiating the active flow process comprises:
accepting the plunger using a mechanical interface mechanically communicated to the actuator; and
moving the plunger within the barrel from the first position to a second position based on predetermined flow properties; and
flow the at least a fluid unidirectionally as a function of the active flow process.

2. The apparatus of claim 1, wherein the plunger comprises a shaft.

3. The apparatus of claim 1, wherein the actuator comprises a linear actuator.

4. The apparatus of claim 1, wherein the actuator comprises a housing.

5. The apparatus of claim 1, wherein the mechanical interface comprises:
an expandable claw; and
a collar configured to constraint the expandable claw.

6. The apparatus of claim 5, wherein the collar is preloaded by a spring.

7. The apparatus of claim 1, wherein the active flow process comprises a reverse flow process and a forward flow process.

8. The apparatus of claim 1, wherein flowing the at least a fluid comprises:
flowing the at least a fluid through a sensor area, wherein the sensor area comprises at least a sensor device and at least a sensor interface.

9. The apparatus of claim 6, wherein the actuator is further configured to:
initiate the forward active flow process when the plunger contacts the spring as the plunger moves within the barrel from the first position to the second position.

10. The apparatus of claim 9, wherein initiating the forward active flow process comprises:
moving the plunger within the barrel from the second position back to the first position.

11. A method for actuating of fluids in a biosensor cartridge, wherein the method comprises:
initiating, using an actuator, an active flow process as a function of an active flow component of a microfluidic device, wherein:
the microfluidic device further comprising a microfluidic circuit containing at least a reservoir configured to contain at least a fluid;
the active flow component in fluidic communication with the at least a reservoir;
the active flow component comprises:
a barrel and a plunger at a first position within the barrel; and
initiating the active flow process comprises:
accepting the plunger using a mechanical interface mechanically communicated to the actuator; and
moving the plunger within the barrel from the first position to a second position based on predetermined flow properties; and
flowing, using the actuator, the at least a fluid unidirectionally as a function of the active flow process.

12. The method of claim 11, wherein the plunger comprises a shaft.

13. The method of claim 11, wherein the actuator comprises a linear actuator.

14. The method of claim 11, wherein the actuator comprises a housing.

15. The method of claim 11, wherein the mechanical interface comprises:
an expandable claw; and
a collar configured to constraint the expandable claw.

16. The method of claim 15, wherein the collar is preloaded by a spring.

17. The method of claim 11, wherein the active flow process comprises a reverse flow process and a forward flow process.

18. The method of claim 11, wherein flowing the at least a fluid comprises:
flowing the at least a fluid through a sensor area, wherein the sensor area comprises at least a sensor device and at least a sensor interface.

19. The method of claim 16, wherein the actuator is further configured to:
initiate the forward active flow process when the plunger contacts the spring as the plunger moves within the barrel from the first position to the second position.

20. The method of claim 19, wherein initiating the forward active flow process comprises:
moving the plunger within the barrel from the second position back to the first position.
